(19) United States
(12) Patent Application Publication
(10) Pub. No.: US 2026/0194796 A1
(43) Pub. Date: Jul. 9, 2026

(54) HARNESS VEST MOUNT

(71) Applicant: Axon Enterprise, Inc., Scottsdale, AZ (US)

(72) Inventor: Juexiao Ning, Phoenix, AZ (US)

(21) Appl. No.: 19/438,884

(22) Filed: Jan. 2, 2026

Related U.S. Application Data
(60) Provisional application No. 63/741,812, filed on Jan. 3, 2025.

(51) Int. Cl. G03B 17/56; A01K 27/00; A45F 5/00; A45F 5/02

(52) U.S. Cl. CPC G03B 17/561; A01K 27/002; A01K 27/008; A45F 5/02; A45F 5/1533

(57) ABSTRACT

A camera mount device worn by a user or an animal during to secure a camera during recording. The camera mount device includes a first mount arm, a second mount arm, a mount lock, and a mount stop. The first mount arm includes a camera mount and a first axle housing, the second mount arm includes a mount interface and a second axle housing, and a mount axle extends within at least the first axle housing and the second axle housing. The mount lock includes a receiver associated with the first mount arm and a lock arm associated with the second mount arm. The mount stop includes a bias spring, a plunger, and a receiving bay. The first mount arm is secured in a position relative to the second mount arm by the plunger and released from the position by an applied force satisfying a force threshold.

### CROSS REFERENCE TO RELATED APPLICATIONS

This application claims the benefit of U.S. Provisional Application 63/741,812 filed January 3, 2025, which is incorporated by reference herein in its entirety.

### FIELD OF THE DESCRIPTION

Embodiments of the present invention relate to mounts for cameras, accessories, and/or other devices.

### BACKGROUND

Public safety personnel, such as police officers and firefighters use cameras to capture events, so that a video and/or audio record exist of what happened in an incident. These cameras may be mounted on vehicles such as cars and drones, and they may also be worn on the body as body worn cameras, and they may also be mounted on vests/collars of trained animals. Numerous mounting systems exist to mount cameras to personnel, vehicles, and animals. Generally, numerous mounting systems exist to mount cameras to articles of clothing and/or surfaces of items. These systems include a variety of coupling methods including those that utilize strong magnets, those that use adhesives, and those that use mechanical interlocks.

### BRIEF DESCRIPTION OF THE DRAWINGS

FIG. 1 illustrates a portion of an exemplary camera mount configured to secure an accessory device to a surface or article of clothing according to the present description.

FIG. 2 illustrates a portion of an exemplary camera mount configured to secure an accessory device to a surface or article of clothing according to the present description.

FIG. 3 illustrates a portion of an exemplary camera mount configured to secure an accessory device to a surface or article of clothing according to the present description.

FIG. 4 illustrates a portion of an exemplary camera mount configured to secure an accessory device to a surface or article of clothing according to the present description.

FIG. 5 illustrates an exemplary camera mount configured to secure an accessory device to a surface or article of clothing according to the present description.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Additionally, any reference to without contact (or similar phrases) may also include reduced contact or minimal contact.

Systems, methods and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

A mount (e.g., vest mount, clothing mount, K9 mount, etc.) according to various aspects of the present disclosure, may include a first component (e.g., base plate, base, front plate, etc.) and a second component (e.g., camera mount, mount housing, body, etc.). Each component may include physically separate, but engageable, structures and/or portions. The engageable structures and portions may be configured to engage one another to couple the first component with the second component. The engageable structures and portions may be configured to engage one another to couple the second component with a camera and/or other accessory device. The base plate may releasably engage the camera mount to an article of wear and/or other mounting surface, thereby coupling the camera mount and the camera to the article of wear and/or other mounting surface.

Each component of one or more components of a mount may comprise one or more rigid, plastic materials, metal materials, and/or composite materials. A rigid material may include materials resistant to deformation under typical usage loads. The one or more rigid materials may include corrosion-resistant materials, UV resistant materials, and/or materials configured to withstand environmental factors. Rigid materials may include metals and metallic alloys (e.g., aluminum, steel, titanium, etc.), composites (e.g., fiberglass, carbon fiber, etc.), and plastics (e.g., polycarbonate/acrylonitrile butadiene styrene, polyether ether ketone, Nylon 6/6, etc.). The rigid materials may also be treated (e.g., heat-treated, galvanized, anodized) and/or painted (e.g., powder-coated, e-coated, etc.).

An article of wear may include articles configured to be worn by a person or animal. For example, an article of wear may include a shirt, a jacket, a hat, a vest, a uniform, pants, gloves, shoes, etc. An article of wear may comprise various materials, such as stiff materials, flexible materials, elastic materials, synthetic materials, natural materials, and combinations thereof.

A base plate may be configured to releasably couple with and/or attach to an article of wear. A base plate may be configured to releasably couple with and/or attach to a mounting surface. A base plate may be integrated with an article of wear and/or a mounting surface. A base plate may be positioned on a first side of the article of wear and/or the mounting surface such that the base plate is exposed. A first portion of the camera mount may engage with the base plate such that the camera mount is disposed proximate to the first side. The first portion of the camera mount may engage with the base plate to couple the camera mount with the article of wear. Thus, an accessory may be coupled to an article of wear via the base plate.

A camera mount may comprise a first interface configured to engage with the base plate to secure the camera mount to the article of wear and/or the mounting surface. A camera mount may comprise a second interface configured to engage with a camera to secure the camera to the camera mount. Engagement of the camera mount with the base plate via the first interface and the camera mount with the camera via the second interface may secure the camera to the base plate (or the mounting surface).

A camera mount may comprise one or more structures configured to engage respective portions of a base plate and/or mounting surface to limit movement of the camera mount relative to the base plate and/or the mounting surface. The one or more structures may be configured to engage respective portions of the base plate and/or the mounting surface in multiple directions, thereby limiting movement of the camera mount in the multiple directions. The structures may be configured to cooperate with respective portions to couple the camera mount to an article of wear and/or a mounting surface via the base plate.

A camera mount may comprise one or more structures configured to engage respective portions of a camera to limit movement of the camera relative to camera mount. The one or more structures may be configured to engage respective portions of the camera in multiple directions, thereby limiting movement of the camera relative to the camera mount in the multiple directions. The structures may be configured to cooperate with respective portions to couple the camera mount to the camera via a camera interface and/or other intermediate structure.

A camera mount may comprise one or more parts configured to engage a base plate to releasably couple the camera mount to the base plate. A part may provide a body from which a structure may extend. A part may comprise a structure configured to engage a respective portion of a base plate. The one or more parts may be movably coupled to one another. For example, a camera mount may comprise a first part and a second part. The first part may be movably connected to the second part. The parts may be configured to articulate relative to one another to secure the camera mount to the base plate and to release the camera mount from the base plate. A camera mount may comprise an adjustable shape in accordance with two or more parts of the camera mount being movably connected.

A camera mount may comprise one or more parts configured to engage a camera and to releasably couple the camera mount to the camera. A part may provide a body from which a structure may extend. A part may comprise a structure configured to engage a respective portion of a camera. The one or more parts may be movably coupled to one another. For example, a camera mount may comprise a first part and a second part. The first part may be movably connected to the second part. The parts may be configured to articulate relative to one another to secure the camera mount to the camera and to release the camera mount from the camera. A camera mount may comprise an adjustable shape in accordance with two or more parts of the camera mount being movably connected.

A camera mount may comprise one or more joints configured to movably couple one or more parts of the camera mount with the base plate and/or the camera. A joint may enable articulation of a first part relative to a second part in one or more directions. A joint may comprise a revolute joint (e.g., pin joint, hinge, etc.), a prismatic joint (e.g., telescoping joint), a cylindrical joint, or any other coupling configured to constrain (e.g., restrict, limit, prevent, etc.) motion of one part relative to another part. Each joint may comprise one or more degrees of freedom. For example, a joint may comprise one degree of freedom, two degrees of freedom, three degrees of freedom, or any required number of degrees of freedom.

In various embodiments, a camera mount may be configured to articulate between at least an unlocked state and a locked state in order to couple with and decouple from a base plate. Articulation of a portion of the camera mount may comprise movement of one or more parts of the camera mount relative to one another. Articulation of the camera mount may comprise movement of the camera mount relative to the base plate. In a locked state, one or more of a position and an orientation of the camera mount may be fixed relative to the base plate. In a locked state, the camera mount may be inseparable from a base plate. In an unlocked state, the camera mount may be free to move relative to the base plate. In an unlocked state, the camera mount may be separable from a base plate.

In various embodiments, a camera mount may be configured to articulate between at least an unlocked state and a locked state in order to couple with and decouple from a camera. Articulation of a portion of the camera mount may comprise movement of one or more parts of the camera mount relative to one another. Articulation of the camera mount may comprise movement of the camera mount relative to the camera. In a locked state, one or more of a position and an orientation of the camera may be fixed relative to the camera mount. In a locked state, the camera mount may be inseparable from a camera. In an unlocked state, the camera may be free to move relative to the camera mount. In an unlocked state, the camera mount may be separable from a camera.

In various embodiments, a camera mount may comprise a lock physically adjustable to dispose the camera mount in an unlocked state and a locked state. A lock may be configured to control articulation of the camera mount relative to the base plate and/or the camera. A lock may selectively apply a physical contact force (e.g., applied force, normal force, friction force, tension force, etc.) to the camera mount, the base plate, and/or the camera to control the articulation. Alternately or additionally, the lock may selectively apply a distant force (e.g., magnetic force) to the camera mount, the base plate, and/or the camera to control the articulation. Controlling articulation may comprise enabling (e.g., allowing) movement of one or more parts relative to one another and disabling (e.g., preventing) movement of one or more parts relative to one another. A lock may enable and prevent movement of one or more parts relative to one another in order to secure and release the camera mount from a base plate and/or a camera. Engagement of a lock may be configured to retain (e.g., secure, lock, etc.) the camera mount in a locked state. Disengagement of a lock may be configured to dispose (e.g., provide, place, etc.) the camera mount in an unlocked state. An unlocked state and the locked state may be dependent on whether the lock is engaged or disengaged. Engagement of the lock may prevent movement of one or more parts of the camera mount relative to one another. Disengagement of the lock may permit (e.g., enable, allow, etc.) movement of one or more parts of the camera mount relative to one another. When engaged, the lock may be configured to secure the camera mount to the base plate and/or the camera. When engaged, the lock may be configured to prevent the camera mount from releasing from the base plate and/or the camera. When disengaged, the lock may be configured to enable the camera mount to release from the base plate and/or the camera.

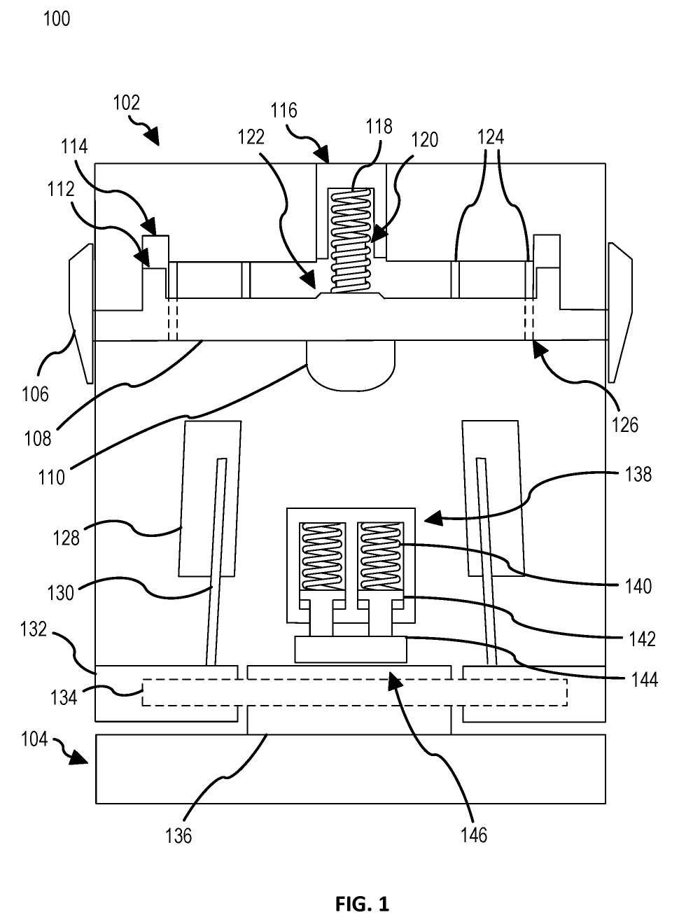

FIG. 1 depicts a portion 100 of a camera mount system of the present description. The camera mount system 100 may be comprised of a first camera arm 102 and a second camera arm 104. The first camera arm 102 may be configured to secure the camera mount system to a base plate, a mounting surface, an article of clothing, and/or other fixture for the camera mount system. The second camera arm 104 may be configured to secure a camera and/or other accessory device to the camera mount system.

In various embodiments, first camera arm 102 may comprise a user interface 106 associated with a mount lock system. In particular, user interface 106 may comprise one or more interaction points disposed on a first side and/or a second side of first camera arm 102. The one or more interaction points of user interface 106 may be coupled to structure 108. Structure 108 may be a bar, a beam, a connector, and/or other structure that extends between the one or more interaction points of user interface 106. Structure 108 may comprise a mount lock arm 110, one or more lock contacts 112, a spring mount 120, a spring contact 122, one or more guide channels 126, and/or one or more additional components of the mount lock system. Additionally, structure 108 may interact with a mount lock receiver via mount lock arm 110, one or more lock stops 114, a first bias spring 118, one or more guides 124, and/or one or more additional features and/or structures of the camera mount system.

In various embodiments, user interface 106 may enable a user to transition the camera mount system between a locked state (e.g., a first state, a secured state, a stored state, etc.) and an unlocked state (e.g., a second state, a released state, an unsecured state, a deployed state, etc.). The locked state may be associated with the second camera arm 104 being secured to the first camera arm 102. The locked state may be associated with the second camera arm 104 being disposed parallel and/or substantially parallel to the first camera arm 102. The unlocked state may be associated with the second camera arm 104 being released from the first camera arm 102. The unlocked state may be associated with the second camera arm 104 being permitted to articulate. The unlocked state may be associated with the second camera arm 104 being permitted to rotate between parallel to the first camera arm 102 and perpendicular to the first camera arm 102.

In various embodiments, manipulation of user interface 106 may transition the camera mount system between the locked state and the unlocked state. In particular, manipulation of user interface 106 may cause translation of mount lock arm 110 such that mount lock arm 110 disengages from a mount lock receiver (e.g., a mount lock receiver of second camera arm 104). Alternatively, or in addition, manipulation of user interface 106 may cause translation of a mount lock receiver such that the mount lock receiver disengages from a mount lock arm of the second camera arm 104. Additionally, translation of mount lock arm 110 to transition between the locked state and the unlocked state may accomplished by an applied force at user interface 106. The applied force may be transferred via structure 108 to spring contact 122. The applied force may compress first bias spring 118 and causing translation of at least mount lock arm 110 in a first direction. It should be noted that while FIG. 1 depicts translation of user interface 106, structure 108, and mount lock arm 110 occurring in a single direction, one or more additional components may be implemented such that translation of user interface 106 and structure 108 occurs in a first direction and mount lock arm 110 translates in a second direction opposite the first direction, perpendicular to the first direction, and/or otherwise unaligned to the first direction (e.g., structure 108 manipulates a lever with a pivot point that translates mount lock arm 110 in the second direction).

In various embodiments, structure 108 may include one or more contact points and/or guides to restrict movement of structure 108 during translation. In particular, structure 108 may comprise one or more lock contacts 112. The one or more lock contacts 112 may approach one or more lock stops 114 during translation of user interface 106, structure 108, and/or mount lock arm 110. Mount lock arm 110 may be associated with a minimum translation point that is associated with a minimum travel distance that causes mount lock arm 110 to disengage from a mount lock receiver of second camera arm 104 (or a mount lock receiver to disengage from a mount lock arm of second camera arm 104). As a result, translation of structure 108 from a resting position past the minimum translation point may cause mount lock arm 110 to disengage from the mount lock receiver and transition from the locked state to the unlocked state. Additionally, one or more lock stops 114 may be positioned at a travel distance greater than the minimum travel distance such that, at a point past the minimum translation point, further translation of structure 108 and/or mount lock arm 110 is prevented. Translation of structure 108 may cause one or more lock contacts 112 to contact one or more lock stops 114 and prevent further translation of structure 108. Further, the one or more locks stops may be configured to prevent damage to structure 108, mount lock arm 110, first bias spring 118, and/or other components of the camera mount system and/or the mount lock system.

In various embodiments, structure 108 may comprise one or more contact points and/or guides configured to constrain movement of structure 108 during translation. In particular, structure 108 may be associated with one or more guides 124. The one or more guides 124 may be aligned with one or more guide channels 126 of structure 108. The one or more guides 124 may be configured as rails, grooves, protrusions, recesses, and/or other structures of first camera arm 102 that engage with, couple with, and/or otherwise cooperate with the one or more guide channels 126 to constrain movement of structure 108. For example, and where user interface 106 translates structure 108 in a first direction, the one or more guides 124 and the one or more guide channels 126 may be aligned to the first direction. Additionally, and during translation of structure 108 in the first direction, the one or more guides 124 and/or the one or more guide channels 126 may cooperate to prevent movement of structure 108 perpendicular to the first direction. Similarly, and during translation of structure 108 in a second direction opposite the first direction, the one or more guides 124 and/or the one or more guide channels 126 may cooperate to prevent movement of structure 108 perpendicular to the second direction.

In various embodiments, mount lock arm 110 may be a structure that extends from structure 108 and is associated with first camera arm 102. Mount lock arm 110 may be configured to engage with, couple with, and/or otherwise cooperate with a mount lock receiver of second camera arm 104. Mount lock arm 110 may at least partially extend from a top surface of structure 108 and/or first camera arm 102. Mount lock arm 110 may extend opposite from a mounting surface associated with the camera mount system. Mount lock arm 110 may extend from first camera arm 102 towards second camera arm 104 when the camera mount system is in the locked state (e.g., second camera arm 104 is disposed parallel to first camera arm 102). Additionally, mount lock arm 110 may include a protrusion that extends into the mount lock receiver in the locked state. Further, the protrusion of mount lock arm 110 may extend in a direction parallel to a direction of movement of mount lock arm 110 during transition from the locked state to the unlocked state. For example, and where mount lock arm 110 translates in the first direction during manipulation of user interface 106, the protrusion may extend such that translation of the mount lock arm 110 withdraws the protrusion from the mount lock receiver to transition from the locked state to the unlocked state.

In various embodiments, mount lock arm 110 may comprise a sloped surface that enables transition from the unlocked state to the locked state. In particular, mount lock arm 110 may engage with mount lock receiver to transition mount lock system from the unlocked state to the locked state. Translation of second camera arm 104 towards first camera arm 102 may cause a portion of second camera arm 104 and/or mount lock receiver to contact mount lock arm 110. Contact between mount lock arm 110 and second camera arm 104 may apply an additional force to mount lock arm 110 that displaces mount lock arm 110. Displacement of mount lock arm 110 may compress first bias spring 118. Additionally, second camera arm 104 may cause mount lock arm 110 to travel past the minimum translation point such that mount lock receiver is aligned with mount lock arm 110. Alignment of mount lock arm 110 and mount lock receiver may permit mount lock arm 110 to engage with the mount lock receiver to transition mount lock system from the unlocked state to the locked state. Further, translation of mount lock arm 110 past the minimum translation point and alignment of mount lock arm 110 with the mount lock receiver may permit the first bias spring to engage mount lock arm 110 with the mount lock receiver. Engagement of mount lock arm 110 with the mount lock receiver may occur due to first bias spring decompressing to cause mount lock arm 110 to extend into the mount lock receiver.

In various embodiments, spring channel 116 may at least partially contain first bias spring 118. In particular, spring channel 116 may provide a fixed structure that first bias spring 118 may be compressed against by translation of user interface 106 and/or mount lock arm 110. Additionally, spring channel 116 may provide one or more side walls that prevent deformation of first bias spring 118 during compression. For example, first bias spring 118 may be compressed by translation of at least spring contact 122 in the first direction and may decompress by translating spring contact 122 in a second direction opposite the first direction. Spring channel 116 may prevent decompression of first bias spring 118 in a direction perpendicular to the first direction and/or the second direction.

In various embodiments, the camera mount system may comprise a securing system. In particular, first camera arm 102 may comprise a securing system that translates second camera arm 104 from a secured position (e.g., a first position, a stored position, etc.) to a deployed position (e.g., a second position, a deployed position, etc.). The securing system may translate second camera arm 104 from the secured position to the deployed position based at least on the mount lock system transitioning from the locked state to the unlocked state. Additionally, second camera arm 104 may be translated from the deployed position to the secured position to transition the mount lock system from the unlocked state to the locked state.

In various embodiments, the securing system may be associated with first camera arm 102 and comprise one or more extension spring channels 128. Additionally, the securing system may comprise one or more extension springs 130 (e.g., one or more additional bias springs). Further, the securing system may be associated with one or more first axle housings 132, a mount axle 134, and/or second camera arm 104. In particular, the one or more extension spring channels 128 may secure a portion of the one or more extension springs 130 in association with first camera arm 102.

In various embodiments, first camera arm 102 and second camera arm 104 may be secured to each other by at least mound axle 134. Second camera arm 104 may be secured to a mounting surface via first camera arm 102. In particular, first camera arm 102 may be secured to a mounting surface by a mount interface. Additionally, second camera arm 104 may be coupled to first camera arm 102 by at least mount axle 134 extending at least partially within one or more first axle housings 132 and one or more second axle housings 136. Further, second camera arm 104 may be configured to rotate around a central axis of mount axle 134. A first portion of the one or more extension springs 130 may be secured within the one or more extension spring channels 128 such that the extending force is applied to the second camera arm via a second portion of the one or more extension springs 130. For example, the first portion of the one or more extension springs 130 may extend along the one or more extension spring channels. A third portion of the one or more extension springs may extend into first axle housing 132 and coil around mount axle 134. The second portion of the one or more extension springs 130 may extend from second axle housing 136 and along second camera arm 104.

In various embodiments, the one or more extension springs 130 may be configured to provide an extending force to second camera arm 104. In particular, the one or more extension springs 130 may be configured such that a rest state of the one or more extension springs 130 is associated with second camera arm 104 being disposed perpendicular to first camera arm 102 and/or past perpendicular relative to the first camera arm 102 (e.g., second camera arm 104 is disposed greater than 90 degrees from first camera arm 102). Rotation of second camera arm 104, around mount axle 134, towards first camera arm 102 may compress the one or more extension springs 130. Rotation of second camera arm 104, around mount axle 134, away from first camera arm 102 may relax the one or more extension springs 130. Accordingly, the one or more extension springs 130 may be configured to apply the extension force to the second camera arm 104 such that, where unsecured, from the secured position to the deployed position. Additionally, the one or more extension springs 130 may be configured to continuously apply the extension force to the second camera arm 104 independent of mount lock system state (e.g., locked state, unlocked state, etc.) and second camera arm 104 position (e.g., secured position, deployed position, an intermediate position, etc.).

In various embodiments, a mount stop system of first camera arm 102 may be configured to secure the second camera arm 104 in the deployed position. In particular, the mount stop system may comprise a first portion of components associated with the first camera arm 102. Additionally, the mount stop system may comprise a second portion of components associated with the second camera arm 102. The first portion of the mount stop system may comprise a mount stop wall 138, one or more second bias springs 140, one or more plungers 142, and a mount stop 144. The second portion of the mount stop system may comprise a mount stop recess 146 associated with second axle housing 136.

In various embodiments, and similar to spring channel 116 and the one or more extension spring channels 128, mount stop wall 138 may comprise a channel that secures the one or more second bias springs 140. Additionally, mount stop wall 138 may comprise an additional channel that permits one or more plungers 142 to extend from within the channel, through the mount stop wall 138, and to the mount stop 144. Further, mount stop wall 138 may be a fixed point that the one or more second bias springs 140 are compressed against and/or extend from.

In various embodiments, one or more second bias springs 140 may be configured to transition the mount stop system between a compressed state (e.g., first state, unlocked state, unsecured state, etc.) and an extended state (e.g., second state, locked state, secured state, etc.). Additionally, the one or more second bias springs 140 may transition the mount stop system from the compressed state to the extended state based at least on mount stop 144 aligning with mount stop recess 146. Further, the one or more second bias springs 140 may transition the mount stop from the extended state to the compressed state based at least on a force threshold.

In various embodiments, one or more second bias springs 140 may be configured to apply a locking force. In particular, one or more second bias springs 140 may be configured to apply the locking force to mount stop 144 via one or more plungers 142. The one or more plungers 142 may be one or more structures associated with the one or more second bias springs 140 and mount stop 144. The one or more plungers 142 may extend through mount stop wall 138. The one or more plungers 142 may have a first length configured to enable mount stop 144 to translate into mount stop recess 146. For example, an in the compressed state, mount stop 144 may be in contact with second axle housing 136. Contact between mount stop 144 and second axle housing 136, at a first side of mount stop 144, may prevent extension of one or more second bias springs 140 and maintain the mount stop system in the compressed state. One or more plungers 142 may contact, couple with, engage with, and/otherwise combine with mount stop 144 at a second side opposite the first side. As a result, one or more plungers 142 may compress one or more second bias springs 140. The one or more second bias springs 140 may apply the locking force to the mount stop 144 and second axle housing 136 via the one or more plungers 142.

In various embodiments, one or more second bias springs 140 may extend from the compressed state to the deployed state based at least on the locking force. In particular, second camera arm 104 may rotate from the first position to the second position. As second camera arm 104 rotates from the first position to the second position, second axle housing 134 may rotate such that mount stop recess 146 translates from an unaligned position (e.g., mount stop 144 is prevented from extending into mount stop recess 146) to an aligned position (e.g., mount stop 144 is permitted to extend into mount stop recess 146). As a result, and in the aligned position, second axle housing 136 may no longer contact mount stop 144 and, via mount stop 144, may no longer maintain compression of one or more second bias springs 140. Further, the locking force applied by one or more second bias springs 140 to one or more plungers 142 may cause translation of mount stop 144 towards and into mount stop recess 146 in the aligned position.

In various embodiments, one or more second bias springs 140 may apply the locking force to mount stop 144 in the deployed state. In particular, one or more second bias springs 140 may be configured to remain at least partially compressed when mount stop 144 and one or more plungers 142 are extended towards and/or into mount stop recess 146. Additionally, the locking force applied by one or more second bias springs 140 may at least partially define the force threshold associated with transitioning from the deployed state to the compressed state. It should be noted that the force threshold may be associated with one or more additional locking structures that contact and/or extend into second axle housing 136, mount axle 134, and/or second camera arm 104. Further, the locking force applied by the one or more second bias springs 140 may maintain second camera arm 104 in the second position for an applied force less than the force threshold. As a result, mount stop 144 and one or more second bias springs 140 may prevent second camera arm 104 from translated from the second position to and/or towards the first position.

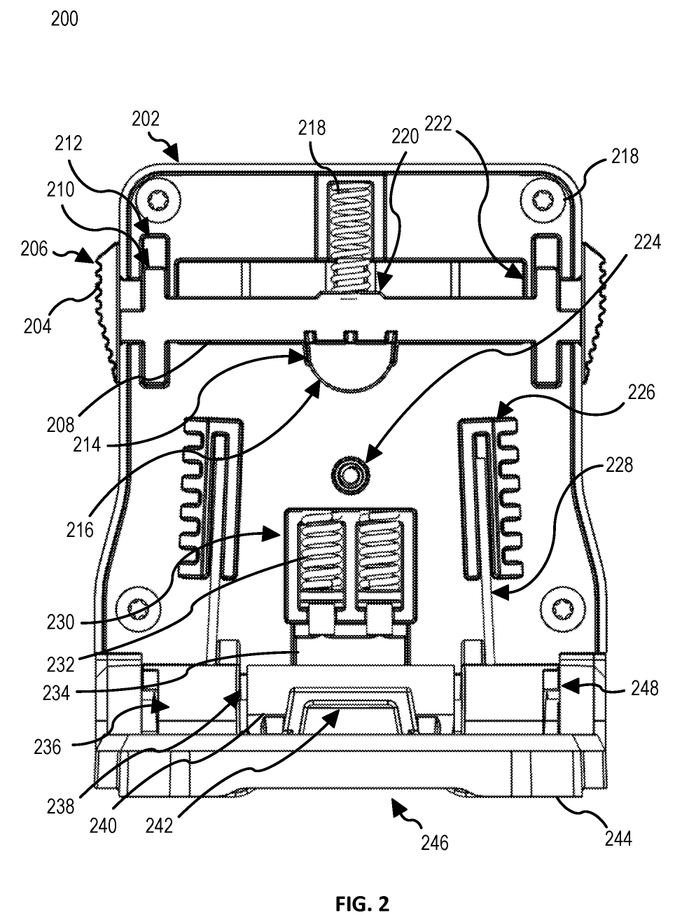

FIG. 2 depicts an example embodiment of portion 100 of a camera mount system of the present description. The example camera mount system may be comprised of a first camera arm defined at least partially be a first mount housing 202 and a second camera arm defined at least partially by second mount housing 244. While the components described with reference to FIG. 2 may mirror the components described with reference to FIG. 1, it is appreciated that individual components may be modified in structure and/or position in various embodiments of the camera mount system.

In various embodiments, camera mount system may be associated with a locked state and an unlocked state. The locked state may be associated with second mount housing 244 being disposed proximate to and parallel to first mount housing 202. The locked state may be associated with mount lock arm 214 engaging with a mount lock arm receiver of second mount housing 244 to maintain second mount housing 244 in a first position. The first position may be associated with second mount housing 244 being disposed proximate to and parallel to first mount housing 202. The unlocked state may be associated with second mount housing 244 being permitted to translate from the first position to a second position and/or one or more intermediate positions. The unlocked state may be associated with mount lock arm 214 disengaging from and/or being unassociated with the mount lock arm receiver of the second mount housing 244.

In various embodiments, user interface 204 may transition camera mount system between a locked state and an unlocked state. User interface 204 may comprise a contact surface 206 that is ridged, gripped, textured, and/or otherwise formed to assist a user in effectively manipulating user interface 204. User interface 204 may be disposed on a first portion and a portion wall, opposite the first portion of first mount housing 202. User interface 204 may be translated in at least a first direction. Translation of user interface 204 in the first direction may cause mount lock arm 214 to translate in a second direction. The second direction may be the same as the first direction. The second direction may be opposite the first direction. The second direction may be perpendicular to the first direction. The second direction may be unaligned with the first direction. Translation of user interface 204 in the first direction may apply a first force to a first bias spring 218 and compress first bias spring 218. Compression of first bias spring 218 may permit translation of mount lock arm 214.

In various embodiments, a first force applied via user interface 204 may transition camera mount system from the locked state to the unlocked state. In particular, application of the first force via user interface 204 may compress first bias spring 218 such that mount lock arm 214 is disengaged from the mount lock receiver 242 of the second mount housing 244. Mount lock arm 214 may be disengaged from the mount lock receiver 242 after traveling at least a minimum distance from a rest position of mount lock arm 214 (e.g., a position that mount lock arm 214 returns to based at least on mount lock arm 214 having no forces applied to it). The first force may be applied to mount lock arm 214 and/or first bias spring by at least a structure 208 that connects one or more user interfaces 204. Structure 208 may be configured to define a maximum travel distance from the rest position of mount lock arm 214 via one or more contact surfaces 210. One or more user interfaces 204 may be translated by a user such that one or more contact surfaces 210 contact one or more stop surfaces 212 to prevent translation of mount lock arm 214 past the maximum travel distance. The maximum travel distance may be associated with a compression limit of first bias spring 218 to mitigate degradation and/or damage to first bias spring 218. Accordingly, where the first force is greater than a transition threshold, the first force may disengage mount lock arm 214 from mount lock receiver 242 and enable translation of second mount housing 244 from the first position.

In various embodiments, a second force applied to the second mount housing 244 may transition camera mount system from the unlocked state to the locked state. In particular, the second force may translate second mount housing 244 towards the first position to engage mount lock arm 214 with mount lock receiver 242 and transition from the unlocked state to the locked state. Mount lock arm 214 may comprise a contact surface 216 that extends from mount lock arm 214 to engage with mount lock receiver 242. For example, translation of second mount housing 244 towards first mount housing 204 and the first position may cause mount lock receiver 242 to apply the second force to contact surface 216. Contact surface 216 may be sloped and/or otherwise configured such that, where second force satisfies an additional transition threshold, mount lock arm 214 applies the second force to first bias spring. The second force, where the additional transition threshold is satisfied, may compress first bias spring such that mount lock arm 214 translates the minimum distance from the rest position and permits the second mount housing 244 to be disposed in the first position. Additionally, and based at least on being disposed in the first position, first bias spring may be relieved of the second force and extend, extension of first bias spring causing mount lock arm 214 to engage mount lock receiver 242 and transition from the unlocked state to the locked state.

In various embodiments, structure 208 may comprise spring contact surface 220. Spring contact surface 220 may be configured such that the first force applied to one or more user interfaces 204 and the second force applied to the mount lock arm 214 compress first bias spring 218. Additionally, first bias spring 218 may be configured to apply a returning force to spring contact surface 220 such that removal of the first force and/or the second force causes mount lock arm 214 to return to the rest position. Further, first bias spring 218 may be associated with and/or at least partially define the transition threshold and the additional transition threshold.

In various embodiments, structure 208 may comprise and/or interact with one or more translation guides 222. In particular, the one or more translation guides 222 may constrain translation of at least structure 208 during manipulation of mount lock arm 214. Additionally, the one or more translation guides 222 may restrict structure 208 to moving parallel to the first direction associated with the first force being applied to one or more user interfaces 204. Alternatively, or in addition, the one or more translation guides 222 may restrict structure 208 to moving parallel to the second direction associated with the first force satisfying the transition threshold and causing translation of mount lock arm 214.

In various embodiments, first mount housing 204 may comprise a mount interface 224. In particular, first mount housing 204 may be secured to at least a mounting surface via mount interface 224. Mount interface 224 may secure first mount housing 204 to the mounting surface such that mounting surface is disposed opposite mount lock arm 214. Alternatively, or in addition, mount interface 224 may secure first mount housing 204 such that second mount housing 244 rotates away from mounting surface when released from the first position by transitioning camera mount system from the locked state to the unlocked state. Accordingly, mount interface 224 may secure a first side of first mount housing 204 to the mounting surface. Further, and while second mount housing 244 is in the first position, second mount housing 244 may extend parallel to first mount housing 204 along a second side of first mount housing 204 opposite the first side.

In various embodiments, one or more second bias springs 228 and one or more third bias springs 230 may manage translation and/or rotation of second mount housing 244 between the first position and the second position. In particular, one or more second bias springs 228 may be configured to apply a rotational bias force to at least second mount housing 244. While in the locked state of camera mount system, the rotational bias force applied by one or more second bias springs 228 may be prevented from translating second mount housing 244 from the first position. While in the unlocked state of camera mount system, the rotational bias force applied by one or more second bias springs 228 may cause second mount housing 244 to translate from the first position, rotate through one or more intermediate positions, and translate into the second position.

In various embodiments, one or more second bias springs 228 may be configured to interact with first mount housing 204 and second mount housing 244. In particular, first mount housing 204 may comprise one or more first extension spring channels 226. Similarly, second mount housing 244 may comprise one or more second extension spring channels. The one or more first extension spring channels 226 and the one or more second extension spring channels may secure a first portion of the one or more second bias springs 228 to first mount housing 204 and a second portion of the one or more second bias springs 228 to second mount housing 244. As a result, the rotational bias force may be applied to first mount housing 204 and second mount housing 244. Additionally, first mount housing 204 is secured by mount interface 224 such that the rotational bias force causes rotation of second mount housing 244 around mount axle 238 between the first position, the one or more intermediate positions, and the second position where the camera mount system is in the unlocked state.

In various embodiments, one or more second bias springs 228 may interact with first mount housing 204 and second mount housing 244. In particular, one or more second bias springs 228 may extend along the one or more first extension spring channels 226 and the one or more second extension spring channels. Additionally, one or more second bias springs 228 may extend through one or more first openings in first axle housing 236 of first mount housing 204 from the one or more first extension spring channels 226. Similarly, one or more second bias springs 228 may extend through one or more second openings 248 in first axle housing 236 into the one or more second extension spring channels. Alternatively, or in addition, one or more second bias springs 228 may extend into and from one or more openings in second axle housing 240 of second mount housing 244. Further, one or more second bias springs 228 may be coiled around mount axle 238 within at least the one or more first axle housings 236 and/or the one or more second axle housings 240.

In various embodiments, one or more third bias springs 232 may transition second mount housing 244 between a secured state and an unsecured state. In particular, one or more third bias springs 232 may be configured to apply a linear bias force to mount stop 234 (e.g., via one or more plungers). Mount stop wall 230 may contain one or more third bias springs 232 during compression and extension of mount stop 234. The secured state of second mount housing 244 may be associated with mount stop 234 being extended, by one or more third bias springs 232, into a mount stop receiver associated with second mount housing 244. The unsecured state of second mount housing 244 may be associated with mount step 234 being retracted from the mount stop receiver and compressing one or more third bias springs.

In various embodiments, second mount housing 244 may be transitioned from the unsecured state to the secured state by one or more third bias springs 232. In particular, at a first time, second mount housing 244 may be disposed in the first position and/or one or more intermediate positions. In the first position and/or the one or more intermediate positions, the mount stop receiver may be disposed such that mount stop 234 is prevented to extending into the mount stop receiver. For example, the mount stop receiver may rotate with second axle housing 240, wherein a central receiver axis that extends along the mount stop receiver is unaligned with an extension axis of mount stop 234 while second mount housing 244 is in the first position and/or the one or more intermediate positions. Additionally, one or more third bias springs 232 may apply the linear bias force to mount stop 234 such that mount stop 234 is pressed towards a wall of second axle housing 240. Rotating second mount housing 244 into the second position may align the central receiver axis of the mount stop receiver with the extension axis of mount stop 234 such that the linear bias force extends mount stop 234 into the mount stop receive.

In various embodiments, the secured state of second mount housing 244 may constrain translation of second mount housing 244 from the second position. In particular, one or more third bias springs may apply the linear bias force to mount stop 234 while mount stop 234 extends into the mount stop receiver. As a result, the linear bias force may be associated with a force threshold that, when satisfied, causes the one or more third bias springs to compress and retract mount stop 234 form the mount stop receiver. For applied forces less than the force threshold, the one or more third bias springs 232 may maintain mount stop 234 within mount stop receiver and prevent rotation of second mount housing 244 from the second position. For applied forces greater than the force threshold, the one or more third bias springs 232 may compress, retract mount stop 234 from mount stop receiver, and permit rotation of second mount housing 244 from the second position.

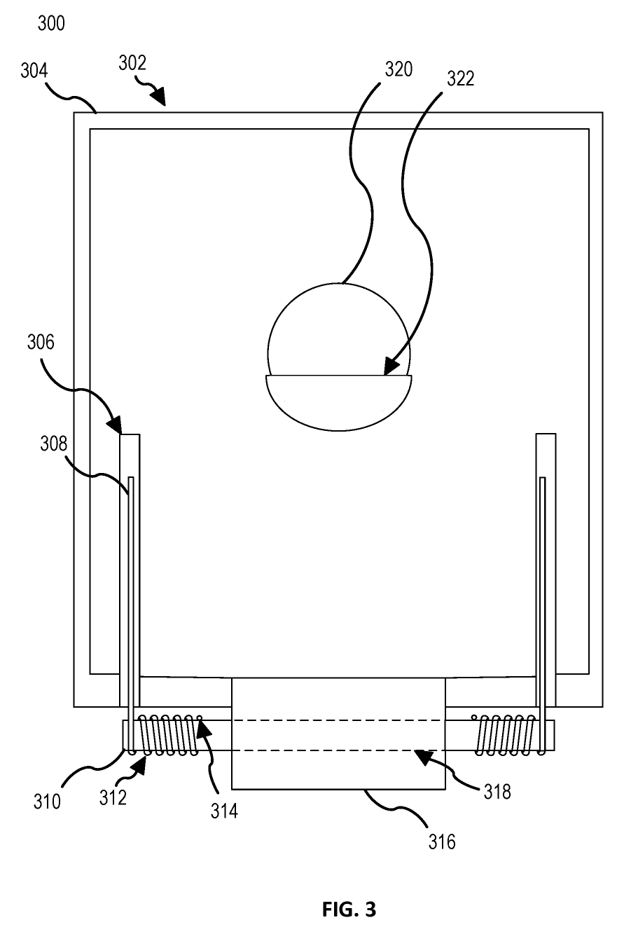

FIG. 3 depicts a portion 300 of a camera mount system of the present description. The camera mount system may be comprised of a first camera arm (e.g., first camera arm 102) and a second camera arm 302 (e.g., second camera arm 104). The first camera arm may be configured to secure the camera mount system to a base plate, a mounting surface, an article of clothing, and/or other fixture for the camera mount system. The second camera arm 302 may be configured to secure a camera and/or other accessory device to the camera mount system.

In various embodiments, second camera arm 302 may comprise a camera mount housing 304 one or more extension spring channels 306 and a mount axle housing 316. Additionally, camera mount housing 304 may comprise a camera interface 320 and a mount lock receiver 322. Camera mount housing 304 may be configured such that camera interface 320 secures a camera associated with the camera mount system on a first side of camera mount housing 304. The first side of camera mount housing 304 may be disposed such that the camera is maintained having a first field of view where video information may be captured. The first field of view may be associated with a “forward” direction, a “facing” direction, and/or other outward direction. The first field of view may be associated with a direction that an animal is facing, wherein the camera mount system secures the camera to the animal via a vest and/or other mounting surface. The first field of view may be associated with a second position of camera mount housing 304. Further, the first side of camera mount housing 304 may be disposed such that the camera is disposed opposite the mount surface when camera mount housing 304 is disposed in the first position and/or is secured by the first camera arm of the camera mount system.

In various embodiments, one or more extension springs 308 may extend along the one or more extension spring channels 306 of camera mount housing 304. The one or more extension springs 308 may comprise a first portion that extends along the one or more extension spring channels 306, a second portion 312 that coils around mount axle 310, and a third portion 314 that extends along the first camera arm of the camera mount system. In particular, the one or more extension springs 308 may apply a rotational force to camera mount housing 304 towards a second position of camera mount housing 304. Additionally, and when camera mount housing 304 is released from the first camera arm, the one or more extension springs 308 may rotate camera mount housing 304 around mount axle 310 from the first position to at least the second position. Further, and when camera mount housing 304 is rotating from the second position, the one or more extension springs 308 may be configured to provide the rotational force to return camera mount housing from an intermediate position to the second position.

In various embodiments, mount lock receiver 322 may be configured to secure camera mount housing 304 in the first position when first camera arm is in the locked state and camera mount housing 304 is disposed in the first position. In particular, an additional rotational force may be applied to camera mount housing 304 in the second position and/or an intermediate position to rotate camera mount housing 304 into the first position. The additional rotational force may be greater than the rotational force and/or a force threshold in order to rotate camera mount housing 304 from the second position to the first position. Additionally, the additional rotational force may compress the one or more extension springs 308 during rotation of camera mount housing 304 from the first position to the second position. Further, the additional rotational force may satisfy an additional threshold associated with a mount lock arm of the first camera arm. As a result of the additional rotational force satisfying the additional threshold, mount lock receiver 322 may engage the mount lock arm and secure camera mount housing 304 in the first position (e.g., second camera arm 302 is disposed proximate to and parallel to the first camera arm).

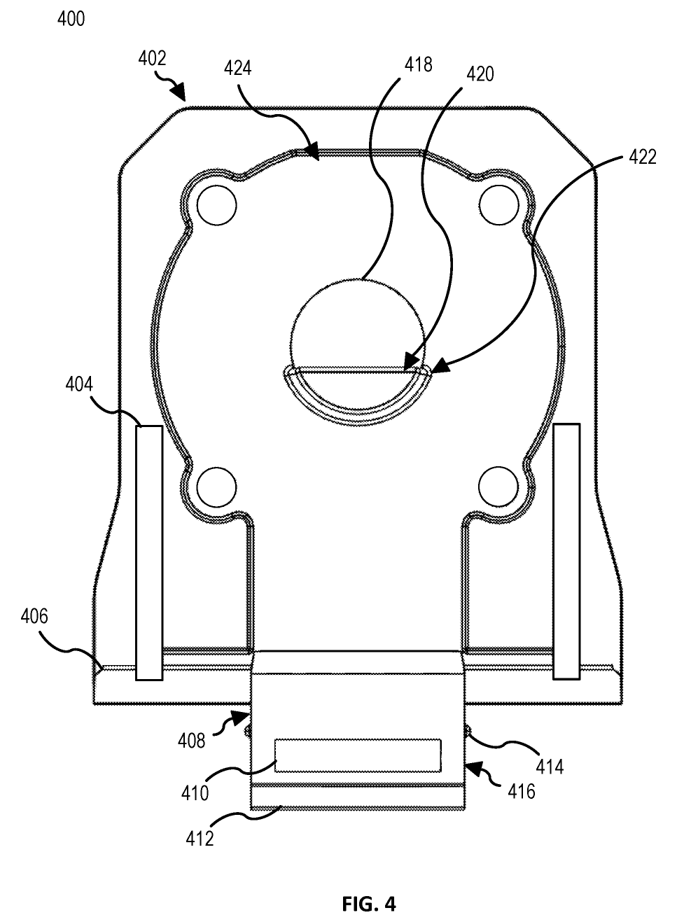

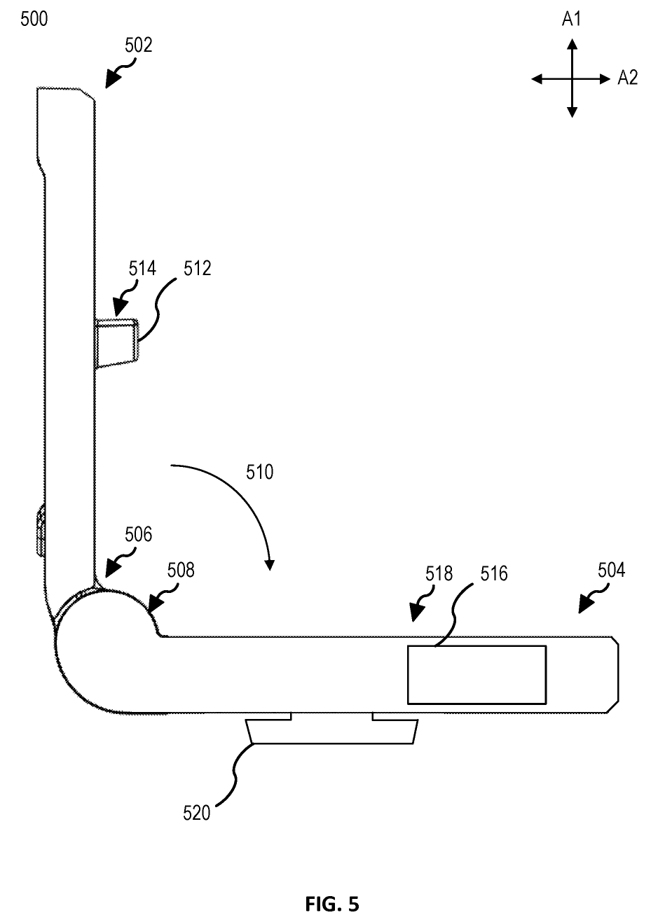

FIG. 4 depicts an example embodiment of portion 300 of a camera mount system of the present description. The example camera mount system may be comprised of a first camera arm (e.g., first camera arm 102, etc.) a second camera arm (e.g., second camera arm 104, etc.) defined at least partially by a camera mount housing 402. While the components described with reference to FIG. 4 may mirror the components described with reference to FIGS. 1-3, it is appreciated that individual components may be modified in structure and/or position in various embodiments of the camera mount system.

In various embodiments, camera mount housing 402 may comprise one or more bias spring channels 404 and a mount housing base 406. The one or more bias spring channels may be configured to receive one or more bias springs (e.g., one or more second bias springs 228). Mount housing base 406 may be coupled to, engaged with, and/or otherwise attached to mount axle housing 408. Alternatively, mount housing base 406 may form and/or comprise mount axle housing 408. Additionally, mount axle housing 408 may comprise a mount stop recess 410, housing stop 412, one or more protrusions 414, and internal channel 416. Further, camera mount housing 402 may comprise a camera interface 418, a lock receiver 420, a lock receiver arm 422, and/or a camera interface recess 424.

In various embodiments, one or more bias springs (e.g., one or more second bias springs 228) may extend within one or more bias spring channels 404 and apply a rotational bias force to camera mount housing 402. In a locked state of the camera mount system and where camera mount housing 402 is disposed in a first position, lock receiver 420 may interact with a mount lock arm of the first camera arm to secure camera mount housing 402 in the first position. As a result, the rotational bias force may be prevented from rotating camera mount housing 402 around a mount axle. Additionally, in an unlocked state of the camera mount system and where camera mount housing 402 is disposed in the first position, lock receiver 420 may be unassociated with the mount lock arm and permit rotation of camera mount housing 402. As a result, the rotational bias force may rotate camera mount housing 402 from the first position through at least an intermediate position to a second position. The second position may be associated with the camera secured to camera interface 418 being in a deployed position and capture information from a desired field of view. Similarly, in a locked state or an unlocked state where camera mount housing is disposed in an intermediate position, lock receiver 420 may be unassociated with the mount lock arm and permit rotation of camera mount housing 402. As a result, the rotational bias force may rotate camera mount housing 402 from the intermediate position to at least a second position.

In various embodiments, camera mount housing 402 may comprise housing stop 412. Housing stop 412 may be a portion of mount housing base 406 and/or mount axle housing 408. Housing stop 412 may be configured to contact a portion of the first camera arm, a mounting surface, and/or other structure to prevent rotation in a first direction. In particular, the rotational bias force applied by the one or more bias springs may be applied in a first direction such that, where unconstrained, the camera mount housing 402 rotates from the first position to the second position. Housing stop 412 may be configured such that, once camera mount housing 402 reaches the second position, the rotational bias force is prevented from inducing further rotation in the first direction past the second position. For example, where the second position disposes camera mount housing at a 90 degree angle from the first camera arm and/or the mounting surface, housing stop 412 may permit rotation between 0 and 90 degrees from the first camera arm and prevent rotation to angles greater than 90 degrees. Generally, the second position may be associated with camera mount housing 402 and the first camera arm forming a suitable angle for capturing a targeted field of view. In some embodiments, the second position may be defined by housing stop 412 contacting a structure and preventing additional rotation in the first direction.

In various embodiments, mount stop recess 410 may be configured to receive a mount stop associated with the first camera arm to secure camera mount housing 402 in the second position. In particular, mount stop recess 410 may extend at least radially into mount axle housing 408. Alternatively, or in addition, mount stop recess 410 may extend at least radially from mount axle housing 408. Additionally, mount stop recess 410 may extend along a central recess axis. Mount stop recess 410 and central recess axis may be fixed relative to camera mount housing 402. As a result, rotation of camera mount housing 402 around a mount axis may modify alignment between the central recess axis and an extension axis associated with the mount stop. For example, and while camera mount housing 402 is in the first position and/or the intermediate position, the central recess axis and the extension axis may be unaligned such that mount stop is prevented from extending into mount stop recess 410. Unaligned may reference the central recess axis and/or the extension axis intersecting such that the mount stop contacts a wall of mount stop recess 410 and is prevented from extending into mount stop recess 410. Alternatively, or in addition, unaligned may reference the central recess axis and/or the extension axis being displaced such that the mount stop is prevented from entering an opening of mount stop recess 410. Generally, unaligned references a state where the mount stop is prevented from entered and/or extending into mount stop recess 410 by a structure of camera mount housing 410 and/or first camera arm (e.g., a mount stop recess is disposed on the first camera arm and the mount stop system is disposed on camera mount housing 410).

In various embodiments, and while camera mount housing 402 is in the second position, the central recess axis and the extension axis may be aligned such that mount stop is permitted to extend into mount stop recess 410. Aligned may reference the central recess axis and/or the extension axis being disposed parallel to each other such that the mount stop is able to extend along one or more walls of mount stop recess 410. Alternatively, or in addition, aligned may reference the central recess axis and/or the extension axis overlapping such that the mount stop is permitted to enter an opening of mount stop recess 410. Generally, aligned references a state where the mount stop is permitted to enter and/or extend into mount stop recess 410 by a structure of camera mount housing 410 and/or first camera arm (e.g., a mount stop recess is disposed on the first camera arm and the mount stop system is disposed on camera mount housing 410).

In various embodiments, and while camera mount housing 402 is in the second position, one or more protrusions 414 may engage with the first camera arm of the camera mount system. Similar to mount stop, the one or more protrusions 414 may interact with the first camera arm to secure camera mount housing 402 in the second position. The one or more protrusions 414 may interact with one or more portions of first arm axle housing(s). The one or more protrusions 414 may interact with one or more recesses of the first camera arm. The one or more protrusions 414 may interact with one or more structures of the first camera arm.

In various embodiments, camera mount housing 402 may be constrained in rotating from the second position in a second direction opposite the first direction. In particular, the second position may be associated with a rotational force threshold. Application of a rotational force less than the rotational force threshold may be prevented from rotating the camera mount housing 402 in the second direction (e.g. towards the first position). Similarly, application of an additional rotational force greater than the rotational force threshold may permit rotation of camera mount housing 402 in the second direction to at least an intermediate position. The rotational force threshold may be associated with a minimum rotational force sufficient to withdraw the mount stop recess 410 and/or disengaging the one or more protrusions 414 from the first camera arm.

In various embodiments, camera mount housing 402 may secure a camera to the camera mount system. In particular, camera mount housing 402 may be configured such that camera interface 418 secures a camera associated with the camera mount system on a first side of camera mount housing 402 within, optionally, camera interface recess 424. For example, the camera interface 418 may secure the camera from being removed from the camera interface recess 424. Additionally, the camera interface recess 424 may secure the camera from lateral movement relative to camera mount housing 402.

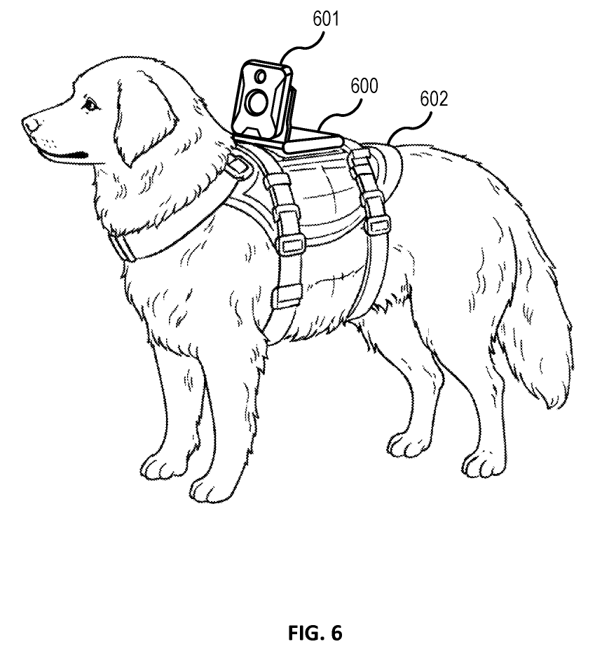

FIG. 5 depicts a camera mount system 500 of the present description. The example camera mount system 500 may be comprised of a first camera arm 502 (e.g., second camera arm 104, camera mount housing 402, etc.) and a second camera arm 504 (e.g., first camera arm 102, etc.) disposed in a position (e.g., referenced as a second position by FIGS. 1-4). While the components described with reference to FIG. 5 may mirror the components described with reference to FIGS. 1-4, it is appreciated that individual components may be modified in structure and/or position in various embodiments of the camera mount system.

In various embodiments, first camera arm 502 may comprise one or more components for interacting with second camera arm 504. In particular, first camera arm 502 may comprise a first axle housing 506, the first axle housing 506 having an internal channel that a mount axle extends at least partially through. Additionally, first camera arm 502 may comprise a first lock portion 512 and a lock recess 514. First lock portion 512 may extend from first camera arm 502 opposite a camera interface and/or other coupling interface for securing an accessory device to first camera arm 502. First lock portion 512 may comprise lock recess 514 for receiving a lock arm associated with second lock portion 518 of second camera arm 504. Alternatively, first lock portion 512 may comprise a lock arm that engages with a lock recess of second lock portion 518. Further, first camera arm 502 may comprise one or more additional components not depicted for interacting with second camera arm 504. For example, first camera arm 502 may comprise a portion of a bias spring for rotating first camera arm 502 opposite direction 510. For example, first camera arm 502 may comprise a mount stop recess for preventing and/or permitting rotation of first camera arm 502 in direction 510. For example, first camera arm 502 may comprise a mount stop for preventing and/or permitting rotation of first camera arm 502 is direction 510.

In various embodiments, second camera arm 504 may comprise one or more components for interacting with first camera arm 502. In particular, second camera arm 504 may comprise a second axle housing 508, the second axle housing 508 having an additional internal channel that a mount axle extends at least partially through. Additionally, second camera arm 504 may comprise a user interface 516 and a second lock portion 518. Second lock portion 518 may extend from second camera arm 504 opposite a mounting surface and/or other mounting interface for securing camera mount system 500. Second lock portion 518 may comprise a lock arm configured to extend into lock recess 514 of first camera arm 502. Alternatively, second lock portion 518 may comprise a lock recess that receives a lock arm of first lock portion 512. Further, second camera arm 504 may comprise one or more additional components not depicted for interacting with first camera arm 502. For example, second camera arm 504 may comprise a portion of a bias spring for rotating first camera arm 502 opposite direction 510. For example, second camera arm 504 may comprise a mount stop recess for preventing and/or permitting rotation of first camera arm 502 in direction 510. For example, second camera arm 504 may comprise a mount stop for preventing and/or permitting rotation of first camera arm 502 is direction 510.

In various embodiments, camera mount system 500 may be configured to return first camera arm 502 to a position (as depicted by FIG. 5). In particular, first camera arm 502 may be configured to be rotated from the position by an applied force that satisfies a force threshold. The force threshold may be associated with interactions between a mount stop recess and a mount stop of first camera arm 502 and second camera arm 504. Where the applied force satisfies the force threshold, the mount stop may withdraw from the mount stop recess and permit rotation of first camera arm 502 in direction 510. Where the applied force does not satisfy the force threshold, the mount stop may remain within the mount stop recess and prevent rotation of the first camera arm 502 in direction 510. For example, where the camera mount system 500 is mounted to a vest of an animal, the animal will be traversing terrain and environments with obstacles. Where incidental contact with the environment occurs (e.g., camera mount system 500 contacts a branch, a piece of fabric, and/or other minor contact), the applied force is unlikely to exceed the force threshold and is unlikely to cause damage to the camera mount system 500 and any associated devices (e.g., a camera mounted to camera mount system 500). Accordingly, and to maintain field of view for the associated device, camera mount system 500 may prevent rotation of the first camera arm 502 in direction 510. For example, where the camera mount system 500 is mounted to a vest of an animal, the animal will be traversing terrain and environments with obstacles. Where robust contact with the environment occurs (e.g., camera mount system 500 contacts a wall, structural objects, and/or other solid obstacle), the applied force is likely to exceed the force threshold and is likely to cause damage to camera mount system 500 and/or any associated devices if first camera arm 502 is maintained in the second position. As a result, the force threshold can be configured such that the applied force causes the mount stop to withdraw from the mount stop recess prior to damage occurring to camera mount system 500 and/or the associated device. Further, the applied force may cause first camera arm 502 to rotate in direction 510 such that camera mount system 500 and the associated device may bypass the contact with the environment. Additionally, first camera arm 502 may rotate opposite direction 510 to return to the second position after bypassing the contact based at least on a rotational bias force applied by a bias spring of camera mount system 500.

In various embodiments, camera mount system 500 may be configured to permit first camera arm 502 to translate from the position and return to the position. In particular, and at a first time, an applied force may be received at first camera arm 502. In response to the applied force satisfying a force threshold associated with first camera arm 502, first camera arm 502 may be released by a mount stop system and permitted to rotate in the first direction 510. In response to the applied force not satisfying the force threshold, first camera arm may remain secured in the position by the mount stop system. Additionally, and at a second time after the first time, the applied force may be removed from first camera arm 502. A rotational bias force being applied by a bias spring of camera mount system 500 may rotate first camera arm 502 opposite direction 510 and return first camera arm 502 to the position and enable to mount stop system to engage first camera arm 502.

In various embodiments, camera mount system 500 may be configured to deploy first camera arm 502 to the position from a locked position. While in the locked position, first lock portion 512 and second lock portion 518 may cooperate to secure first camera arm 502 proximate to second camera arm 504. At a third time prior to the first time, user interface 516 may be operated to disassociate first lock portion 512 and second lock portion 518. Disassociating first lock portion 512 and second lock portion 518 may cause the rotational bias force to rotate first camera arm 502 opposite direction 510 such that first camera arm 502 is disposed in the position.

In various embodiments, camera mount system 500 may be configured to secure first camera arm 502 in the locked position from the position. While in the position and at a fourth time after the second time, a locking force may be applied to first camera arm 502 such that the mount stop system disengages first camera arm 502. The locking force may be applied to the first camera arm to overcome the rotational bias force until the first camera arm 502 is disposed in the locked position. Disposing first camera arm 502 in the locked position may associate first lock portion 512 and second lock portion 518 such that first lock portion 512 and second lock portion 518 cooperate to secure first camera arm 502 in the locked position.

Embodiments according to various aspects of the present disclosure comprise a mount system. For example, and with brief reference to FIG. 6, a mount system may comprise mount 100. A first mount arm of mount 600 may be coupled to portable device 601. Portable device 601 may comprise a camera. A second mount arm of mount 600 may be coupled to article of wear 602. Article of wear 602 may comprise a harness for a canine and/or other animal.

The foregoing description discusses preferred embodiments of the present invention, which may be changed or modified without departing from the scope of the present invention as defined in the claims. Examples listed in parentheses may be used in the alternative or in any practical combination. As used in the specification and claims, the words ‘comprising,’ ‘comprises,’ ‘including,’ ‘includes,’ ‘having,’ and ‘has’ introduce an open-ended statement of component structures and/or functions. In the specification and claims, the words ‘a’ and ‘an’ are used as indefinite articles meaning ‘one or more.’ While for the sake of clarity of description, several specific embodiments of the invention have been described, the scope of the invention is intended to be measured by the claims as set forth below. In the claims, the term “provided” is used to identify an object that is not a claimed element of the invention but an object that performs the function of a workpiece that cooperates with the claimed invention. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”. A person of ordinary skill in the art will appreciate that this disclosure includes any practical combination of the structures and methods disclosed. While for the sake of clarity of description several specifics embodiments of the invention have been described, the scope of the invention is intended to be measured by the claims as set forth below. Where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The words “herein,” “hereunder,” “above,” “below,” and other word that refer to a location, whether specific or general, in the specification shall refer to any location in the specification.

What is claimed is:

1. A camera mount system, the camera mount system comprising:
a first mount arm comprising a camera mount and a first axle housing;
a second mount arm comprising a mount interface and a second axle housing;
a mount axle that extends within at least the first axle housing and the second axle housing, the mount axle at least partially securing the first mount arm and the second mount arm;
a mount lock comprising a mount lock receiver associated with the first mount arm and a mount lock arm associated with the second mount arm; and
a mount stop comprising a bias spring, a plunger, and a receiving bay, wherein the mount stop secures the first mount arm in a first position relative to the second mount arm and releases the first mount arm from the first position in response to an applied force satisfying a force threshold.

2. The camera mount system of claim 1, where the first position comprises the first mount arm extending perpendicular to the second mount arm.

3. The camera mount system of claim 1, further comprising an additional bias spring comprising a first bias spring arm that extends at least partially along the first mount arm and a second bias spring arm that extends at least partially along the second mount arm, the additional bias spring configured to apply an extension force to at least the first mount arm.

4. The camera mount system of claim 1, the mount lock configured to secure the first mount arm in a second position, the second position comprising the first mount arm extending parallel to the second mount arm and the mount lock arm extending at least partially within the mount lock receiver to secure the first mount arm.

5. The camera mount system of claim 1, wherein the mount stop is associated with a first state and a second state, wherein the first mount arm is secured in the first position by the mount stop in the first state and the first mount arm is permitted to rotate around the mount axle by the mount stop in the second state.

6. The camera mount system of claim 5, wherein the first state of the mount stop is associated with the bias spring of the mount stop extending the plunger into the receiving bay to secure the first mount arm in the first position.

7. The camera mount system of claim 5, wherein the second state of the mount stop is associated with the bias spring being compressed such that the plunger is removed from the receiving bay to enable rotation of the first mount arm around the mount axle.

8. A method for securing a camera coupled to a camera mount in a first position, the method comprising:
releasing a first mount arm from a second position, the first mount arm disposed at least partially adjacent to a second mount arm in the second position;
applying, via a first bias spring, a deployment force that transitions the first mount arm from the second position to the first position;
extending, via a second bias spring, a mount stop from a first state to a second state, wherein extending the mount stop to the second state causes the mount stop to extend into a receiving bay of the first mount arm; and
securing, via the mount stop, the first mount arm in the first position.

9. The method of claim 8, wherein:
a mount lock arm associated with the second mount arm extends at least partially into a mount lock receiver associated with the first mount arm to secure the first mount arm in the second position; and
the mount lock arm is withdrawn from the mount lock receiver to release the first mount arm from the second position.

10. The method of claim 8, wherein the deployment force is a rotational force applied by the first bias spring to rotate the first mount arm from the second position to the first position.

11. The method of claim 8, wherein the second bias spring is associated with a force threshold, the second bias spring configured to maintain the first mount arm in the first position in response to one or more first applied forces less than the force threshold and permit the first mount arm to transition from the first position in response to one or more second applied forces greater than the force threshold.

12. A camera mount system, the camera mount system comprising:
a first mount arm comprising a camera mount associated with a first position and a second position;
a second mount arm comprising a mount interface that secures the camera mount to a mount surface;
a first bias spring applying a first force to the first mount arm; and
a mount stop comprising a second bias spring, wherein:
the mount stop secures the first mount arm in the first position via a first state of the mount stop;
the mount stop permits the first mount arm to translate from the first position in a second state of the mount stop; and
the mount stop is configured to transition from the first state to the second state based at least on a force threshold being satisfied.

13. The camera mount system of claim 12, wherein:
at a first time, the first mount arm is secured in the second position by a mount lock arm of the second mount arm extending at least partially within a mount lock receiver of the first mount arm; and
at a second time, the first mount arm is released from the second position by the mount lock arm withdrawing from the mount lock receiver.

14. The camera mount system of claim 12, wherein the first state of the mount stop is associated with the second bias spring extending the mount stop into a receiving bay of the first mount arm.

15. The camera mount system of claim 14, wherein the first position of the first mount arm permits the second bias spring to extend the mount stop into the receiving bay of the first mount arm and transition to the first state of the mount stop.

16. The camera mount system of claim 14, wherein:
the receiving bay is disposed on a first axle housing of the first mount arm; and
the first position of the first mount arm aligns the receiving bay with the mount stop to enable the mount stop to transition into the first state and extend within the receiving bay.

17. The camera mount system of claim 12, wherein the second state of the mount stop is associated with the second bias spring being compressed and preventing the mount stop from extending within a receiving bay of the first mount arm.

18. The camera mount system of claim 12, wherein:
the first mount arm is disposed in the first position at a first time;
the mount stop is disposed in the first state at the first time; and
the first mount arm is translated from the first position towards the second position at a second time by an applied force satisfying the force threshold.

19. The camera mount system of claim 18, wherein:
the applied force is applied to the mount stop by a receiving bay of the first mount arm; and
the second bias spring is compressed to withdraw the mount stop from the receiving bay based at least on the applied force satisfying the force threshold.

20. The camera mount system of claim 18, wherein:
the applied force is removed at a third time after the second time, the applied force removed at a third position between the first position and the second position;
the first bias spring, at the third time, causes the first mount arm to translate from the third position to the first position; and
the second bias spring, at the third time, extends the mount stop into a receiving bay of the first mount arm to secure the first mount arm in the first position.
